(19) United States
(12) Patent Application Publication
(10) Pub. No.: US 2014/0112732 A1
(43) Pub. Date: Apr. 24, 2014

(54) Expanding Dowel Rod Structure

(71) Applicant: ELECTRO-MOTIVE DIESEL, INC., LaGrange, IL (US)

(72) Inventor: Joseph Randall Bushen, Crest Hill, IL (US)

(73) Assignee: ELECTRO-MOTIVE DIESEL, INC., LaGrange, IL (US)

(21) Appl. No.: 13/655,715

(22) Filed: Oct. 19, 2012

(51) Int. Cl. F16B 13/06

(52) U.S. Cl. 411/55

(57) ABSTRACT

An expanding dowel rod structure for coaxially aligning at least 2 separate workpieces having circular apertures therein and/or securely attaching a boss in a circular aperture in a workpiece providing resistance to shearing is provided. The expanding dowel rod structure is comprised of a small number of easily machinable or obtainable pieces, is simple to insert and secure, automatically coaxially aligns the dowel rod structure in a circular aperture with generally even force across substantially all of the contacting surfaces thereof.

### TECHNICAL FIELD

The present disclosure relates generally to a method and apparatus for coaxially aligning at least 2 separate workpieces having circular apertures therein and/or securely attaching a boss in a circular aperture in a workpiece.

### BACKGROUND

Sometimes it is desired to align two structures (or more), such as workpieces, having circular apertures therein, coaxially, with a high degree of precision. Additionally, sometimes it is desired to be able to place a boss or protrusion, for various reasons, in a work piece securely and simply, using a device that is relatively cheap to produce.

One attempt to resolve these issues in the past has included use of standard slotted pins. However, in some applications the shear force on the resulting dowel is too large for such an apparatus and method to be effective. More specifically, since standard slotted pins are generally hollow, they do not contain an inner core and thus are susceptible to shearing at relatively low loads.

Another apparatus and method disclosed in the prior art is disclosed in U.S. Pat. No. 6,056,489 issued on May 2, 2000 to Keller (the “'489 patent”). The '489 patent discloses an expansion dowel for use in attaching members using a circular bore. Specifically, the '489 patent discloses an expansion dowel including: a cylindrical, expandable dowel body having a plurality of axial slots opening at a front, in a setting direction, of the dowel body, and a bore which tapers in the setting direction in a region of the axial slots; an expansion sleeve arranged inside of the dowel body and tapering in the setting direction, the expansion sleeve having a conical tapering, in the setting direction; the bore having a plurality of slots extending in an axial direction; a plurality of projections projecting from an outer surface of the sleeve and adapted to displace in the axial slots of the dowel body; and an expansion member axially displaceable in the bore of the dowel body.

While the expansion dowel of the '489 patent may be useful for some applications, it does not serve a general utility for all applications. Specifically, the machined parts necessary to utilize the expansion dowel of the '489 patent are very intricate in design and use, requiring significant machining to achieve. Furthermore, the expansion of the dowel sleeve disclosed in the '489 patent is accomplished by the pounding of an expansion member by a worker. This expansion may be considered undesirable in many applications because the pounding of a hammer is generally not as precise a work movement as may be desired and may create undesirable and imprecise loads being placed on the workpieces in which the expansion dowel disclosed in the '489 patent may be used. Additionally, the use of a hammer can sometimes result in damage to the workpieces themselves. For this reason, it may be desired to have an expanding dowel rod structure that is formed from relatively simple, easy to machine and/or obtain pieces for, which may be simply, easily and precisely used by a worker, which provides the desired force or load on the workpiece it is being used in, and which are not susceptible to shearing at relatively low loads.

### SUMMARY

In one aspect, the disclosure involves the use of an expanding dowel rod structure comprised of a dowel sleeve, an inner thrust retainer, and a bolt. More specifically, in an aspect of the disclosure, the thrust retainer is tapered to deform the expanding dowel sleeve in order that the deformation will interfere with and bear force on the bore of the workpieces that are being doweled. In an aspect disclosed herein, both the expanding dowel sleeve and the thrust retainer have tapered inner/outer faces, respectively, that mate, thus causing the desired expansion. As discussed above, the expanding dowel rod structure disclosed herein may be used in connection with workpieces having circular bores that need to be coaxially aligned and secured. In an aspect of the disclosure, in some applications, it may be desirable to be able to vary the force exerted on the bores of the dowel holes without varying the bore size itself, an aspect which may be accomplished by embodiments of the disclosure set forth herein.

In yet another aspect of the disclosure, an expanding dowel rod structure is disclosed that can be used to securely add a boss to a workpiece having a circular bore therein, thus saving considerably in cost and simplicity over prior art methods of casting a relatively thick workpiece and machining it down to the desired boss height. More specifically, in such an aspect, the dowel sleeve disclosed herein may be placed in a circular bore with a desired portion sticking out of the bore. The bolt may then be tightened in the thrust retainer disclosed herein to a desired torque such that the force acts on the bore of the workpiece allowing the assembly to be rigid in the workpiece and act as a boss.

### BRIEF DESCRIPTION OF THE DRAWINGS

FIG. 1 is a partial cutaway isometric view showing an expanding dowel rod structure in accordance with the disclosure in both pre-use and in-use configurations;

FIG. 2 is an overhead plan view of the expanding dowel rod structure of FIG. 1 in an in-use (force loading) configuration;

FIG. 3 is an overhead plan view of the expanding dowel rod structure of FIG. 1 in a pre-use (non-force loading) configuration;

FIG. 4 is an isometric view of a dowel sleeve in accordance with the expanding dowel rod structure shown in FIG. 1;

FIG. 5 is an isometric view of a thrust retainer in accordance with the expanding dowel rod structure shown in FIG. 1;

FIG. 6 is an isometric view of an alternate embodiment of a thrust retainer operable for use in connection with an expanding dowel rod structure disclosed herein;

FIG. 7 is a full cutaway isometric view showing the expanding dowel rod structure of FIG. 1;

FIG. 8 is a partial cutaway, partial phantom isometric view showing the expanding dowel rod structure of FIG. 1; and

FIG. 9 is an isometric view showing an expanding dowel rod structure in accordance with an embodiment of the present disclosure being used to create a boss in a workpiece having a circular aperture therein.

### DETAILED DESCRIPTION

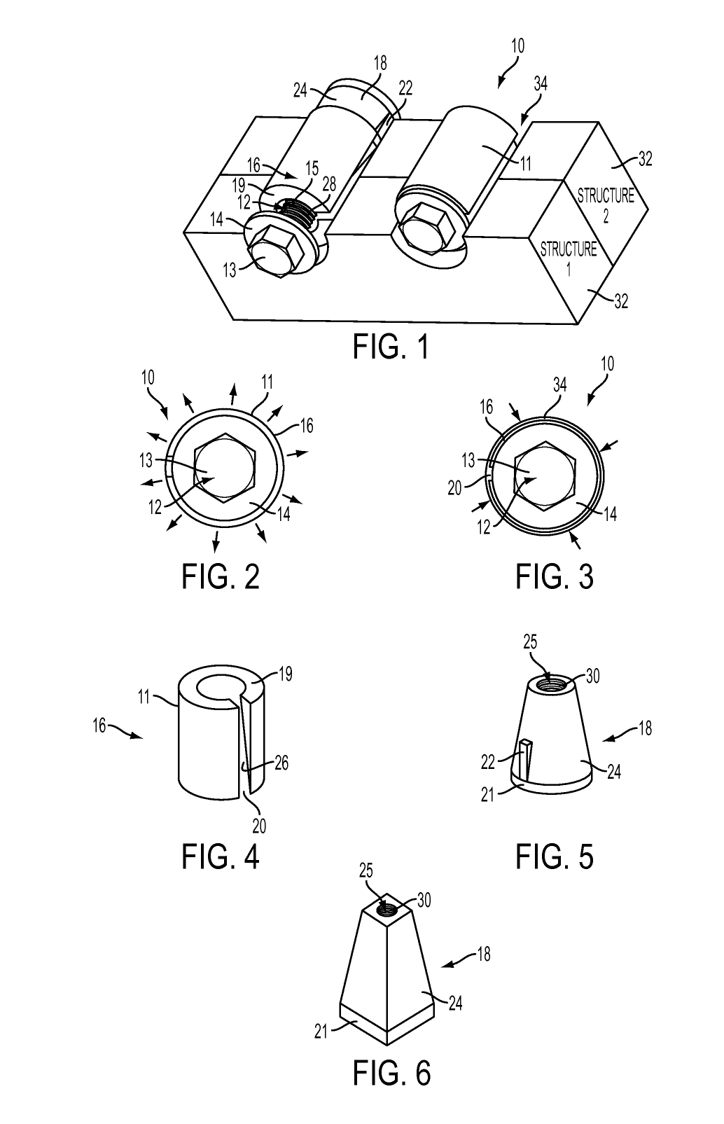

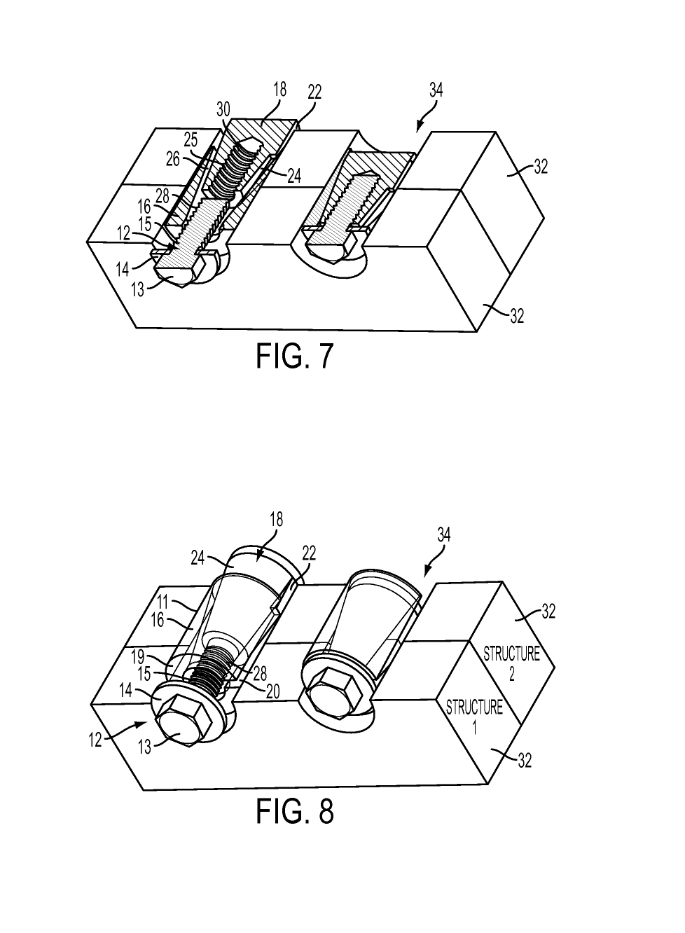

As shown best in FIGS. 1, 7 and 8, an expanding dowel rod structure 10 in accordance with an aspect of the disclosure is generally designated as reference numeral 10. In accordance therewith, the dowel rod structure 10 may be formed by a dowel sleeve 16, a thrust retainer 18 and a bolt 12. The dowel sleeve 16 may have a cylindrical shape defining a circular outer face 11, and include a shoulder 19 located on a top portion thereof and be provided with an axial bore that is tapered forming a dowel sleeve 16 tapered inner face 26. Consistent with this aspect of the disclosure, the wide portion of the dowel sleeve 16 tapered inner face 26 is located at the bottom of the dowel sleeve 16 and tapers toward the narrow portion of the dowel sleeve 16 tapered inner face 26 located proximate a top portion of the dowel sleeve 16. Additionally, the dowel sleeve 16 may preferably include a slot 20 formed on an axial side thereof and which may protrude radially therethrough. In an aspect of the disclosure, the slot 20 imparts to the dowel sleeve 16 the flexibility which is necessary for expansion of the dowel sleeve 16 to occur. In an aspect consistent with the present disclosure, the slot 20 extends the entire length of the dowel sleeve 16 in order to allow uniform expansion of the dowel sleeve 16 by the thrust retainer 18.

Consistent with an aspect of the disclosure, the thrust retainer 18 includes a tapered outer face 24, an axial inner bore 25 having inner threads 30 therein, and a nub 22 on an outer portion thereof. In an aspect of the disclosure, the thrust retainer 18 may include a band portion 21 located on a bottom portion thereof, the band portion 21 being defined by a face having a constant radius. Also in an aspect of the disclosure, the nub 22 may be wedge-shaped in order to facilitate the engagement of the nub 22 within the slot 20 while preventing the nub 22 from sticking out of the slot 20 and thus interfering with the placement of the dowel rod structure 10 in a bore 34 of workpieces 32 in which the dowel rod structure 10 is being utilized. Consistent with this aspect of the disclosure, the nub 22 may be located on or above said band 21 on the tapered outer face 24 on the thrust retainer 18. Also consistent with the disclosure, the tapered outer face 24 of the thrust retainer 18 may be provided with a taper angle similar or identical to the taper of the tapered inner face 26 of dowel sleeve 16. Consistent with an aspect of the disclosure the shape of the tapered outer face 24 of the thrust retainer 18 and the tapered inner face 26 of the dowel sleeve 16 may be conical or pyramidal.

Consistent with an aspect of the disclosure, the bolt 12 may be comprised of a head 13 and shank 15, and may preferably include a washer 14 positioned under the head 13 and outer threads 28 positioned on the shank 15 of bolt 12. The washer 14 may be a separate element or may be machined integrally with the head 13 as is known to those of ordinary skill in the art. Conversely, the head 13 may be large enough to preclude the need for a washer 14. The important aspect of the size of the head 13 and/or washer 14 being that the head 13 or washer 14 should be large enough that an underside thereof may sufficiently engage the shoulder 19 of the dowel sleeve 16 when the expanding dowel rod structure 10 disclosed herein is in use.

In an aspect consistent with the disclosure, the thrust retainer 18 inner threads 30 are preferably shaped to mate with the outer threads 28 of bolt 12. Further, in an aspect of the disclosed embodiment, the nub 22 is shaped to be received in slot 20 of dowel sleeve 16 to prevent relative rotational movement between the thrust retainer 18 and the dowel sleeve 16 when the dowel rod structure 10 is being tightened.

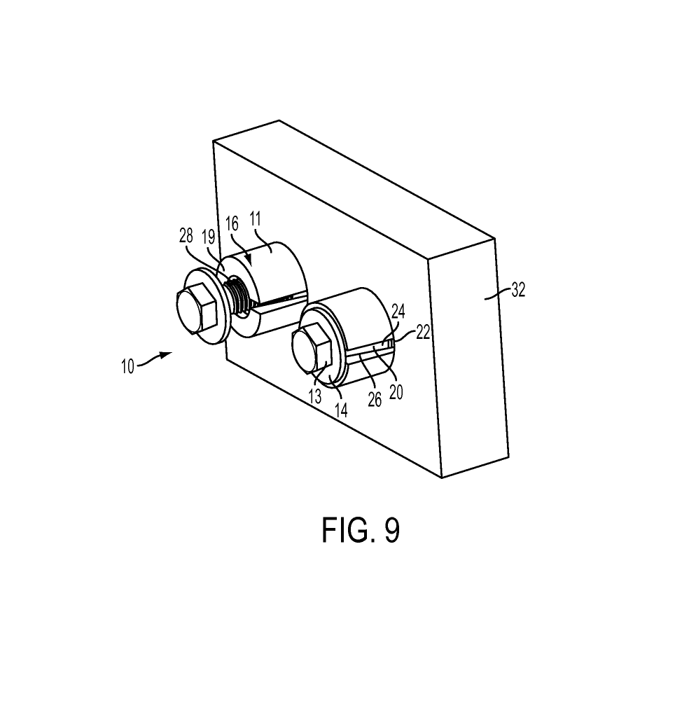

As shown in FIGS. 1, 3, 6, 7, 8 and 9 and as discussed above, the expanding dowel rod structure 10 components may be loosely assembled before being placed in bore 34 in workpieces 32 for expansion. Specifically, the top portion of thrust retainer 18 may be placed in the bottom portion of the dowel sleeve 16 by aligning the slot 20 with the nub 22. Next bolt 12 may be loosely placed in the axial inner bore 25 of the thrust retainer 18 thereby capturing the shoulder 19 of dowel sleeve 16 between the underside either of the head 13 of the bolt 12 or the underside of washer 14 and the thrust retainer 18. At this time, bolt 12 head 13 may be turned sufficiently so that just the first few threads 28 of bolt 12 engage the inner threads 30 of the axial inner bore 25 of the thrust retainer 18 thereby capturing the dowel sleeve 16 without expanding it significantly.

As can be seen in FIG. 3, at this time there is no force being exerted by the dowel rod structure 10 against the bore(s) 34 of workpiece(s) 32 as this initial “loose” construction does not cause the tapered outer face 24 of the thrust retainer 18 to press up and against tapered inner face 26 of dowel sleeve 16 and thus does not cause significant expansion of dowel sleeve 16 at this time. As such, the dowel rod structure 10 comprised of the dowel sleeve 16, thrust retainer 18, and bolt 12 may be placed in the bores 34 of the workpieces 32 (as shown in FIGS. 1, 3, 6 and 7) or, in the case of creating a boss (as shown best in FIG. 8), in the bore 34 of a single workpiece 32 while in the initial “loose” configuration.

Next, consistent with the use of the dowel rod structure 10 as disclosed herein, the bolt 12 head 13 may be tightened to provide the desired expansion of the dowel sleeve 16 and thus be anchored into the work piece(s) 32. Specifically, the head 13 of the bolt 12 (shown herein as a hex head, but which could be of practically any configuration as is known by those of ordinary skill in the art), could begin being torqued by an operator. Caused thereby, the thrust retainer 18 tapered outer face 24 is driven up and into the similarly-shaped dowel sleeve 16 tapered inner face 26 causing dowel sleeve 16 to expand radially, and generally evenly, across the entire outer face 11 of dowel sleeve 16. More specifically, upon application of a load by torqueing of bolt 12, the underside of head 13 or washer 14 engages shoulder 19 of dowel sleeve 16 causing axial relative displacement of the thrust retainer 18 into the dowel sleeve 16. The interaction of tapered outer face 24 of thrust retainer 18 and tapered inner face 26 of dowel sleeve 16 as thrust retainer 18 is pulled upwardly by bolt 12 results in generally uniform expansion of the dowel sleeve 16 outer face 11. Upon expansion of the sleeve 16 radially, as shown best in FIG. 2, the outer face 11 of the dowel sleeve 16 is pressed into the bore(s) 34 and frictionally engages it/them. The operator may continue torqueing head 13 of bolt 12 to a desired and/or pre-determined torque level until the desired expansion of dowel sleeve 16 has been reached.

It should be noted that the taper of the inner face 26 of the dowel sleeve 16 need not exactly match the taper of the outer face 24 of the thrust retainer 18 and may be determined in order to provide the desired amount of pressure and displacement of the dowel sleeve 16 depending on the desired application. It should also be noted that the disclosure of the present invention is useful in that the force exerted by the dowel sleeve 16 outer face 11 on the bore(s) 34 may be relatively precisely controlled, compared with some prior art “hammer” methods, by specifying an exact torque to be applied to bolt 12 head 13 by an operator. Further, as discussed above, and as shown best in FIG. 8, the expanding dowel rod structure 10 disclosed herein can be used to add a boss to a workpiece 32. Specifically, rather than tying two (or more) workpieces 32 together, the expanding dowel rod structure 10 can simply be placed in a bore 34 of a single workpiece 32 and expanded as disclosed herein to form the desired boss.

Consistent with an aspect of the disclosure as disclosed herein, the angle of the outer face 24 of the thrust retainer 18 (and thus the corresponding angles of the inner face 26 of the dowel sleeve 16) may vary greatly depending on the geometries and engineering requirements, limitations, tolerances, etc. that are faced for the application in which the expanding dowel rod structure 10 disclosed herein is used. Similarly, the shape, size, length, threading, etc., of the bolt 12 may vary as well. And, in accordance therewith, the exact width, composition, etc., of the dowel sleeve 16, thrust retainer 18, and bolt 12 may vary greatly based upon the same variables discussed above as would be recognizable to a person of ordinary skill in the art.

Accordingly, it should be understood that the disclosure does not require any specific size, tolerance, material of manufacture, etc., for the dowel sleeve 16, thrust retainer 18, or any other piece, part, component disclosed herein. However, consistent with the embodiment disclosed herein, the angle of the outer face 24 of the thrust retainer 18 may be about 10 degrees and the angle of the inner face 26 of the dowel sleeve 16 may be similar thereto. A ¾ inch bolt would be operable in accordance with the disclosure and the components disclosed herein could be made of any operable material including carbon steel, such as 0.48-0.66% Carbon, heat treated, 45-55 HRC.

### INDUSTRIAL APPLICABILITY

The disclosed expanding dowel rod structure 10 is useful for coaxially aligning and securing at least 2 separate workpieces 32 having circular apertures or bores 34 therein and/or for securely attaching a boss in a circular aperture in a workpiece 32. Additionally, the disclosed dowel rod structure 10 may be used in almost any application where, for example, add-on parts must be added to and/or secured to workpieces 32 using a through-assembly, and which require, or could utilize, anchorable attachment devices. Non-limiting examples of uses and/or applications in which the dowel rod structure 10 disclosed herein could be used include almost any application where traditional slotted pins and/or coiled spring pins may have been used in the past. Such applications include, but are not limited to: automotive; manufacturing; locomotive; aeronautical; industrial; building; et al. applications. More specifically, the apparatus disclosed herein may be used in applications wherein it is needed to secure two (or more) workpieces 32 together utilizing circular bores 34 in the workpieces 32, and particularly, wherein it is desired to use an attachment device that is resistant to shear forces in such applications.

More specifically, it is noted that the use of the dowel rod structure 10 in accordance with the disclosure containing the thrust retainer 18 element as disclosed herein provides significant mass and a core to the dowel sleeve 16 that makes the dowel rod structure 10 of the present disclosure resistant to shearing at relatively low loads. This is particularly useful when the dowel rod structure 10 disclosed herein is used to coaxially secure two or more workpieces 32 through bores 34 as the shear forces against the dowel rod structure 10 in such applications can be relatively high, particularly depending on the applications in which the workpieces 32 are being used.

Further, consistent with aspects of the disclosure, the dowel rod structure 10 disclosed herein may be used in applications wherein it is desired to use a securing structure that may be formed relatively easily and simply from readily available and relatively inexpensive materials. Additionally, the dowel rod structure 10 disclosed herein is particularly useful in securing two or more workpieces 32, or providing a boss to a single workpiece 32, when it is desired to control the force being exerted against the bores 34 of the workpiece(s) 32 with some degree of precision.

It will be apparent to those skilled in the art that various modifications and variations can be made to the disclosed dowel rod structure 10 disclosed herein without departing from the scope of the disclosure. Other embodiments of the dowel rod structure 10 may be apparent to those skilled in the art from consideration of the specification disclosed herein. It is intended that the specification and examples be considered as exemplary only, with a true scope of the disclosure being indicated by the following claims and their equivalents.

What is claimed is:

1. An expanding dowel rod structure, comprising:
a dowel sleeve having a cylindrical outer face, a shoulder located on a top portion thereof, an axial bore therethrough, and a slot extending through said dowel sleeve for an entire length thereof, wherein said dowel sleeve axial bore tapers from a narrow portion proximate a top of said dowel sleeve to a wider portion proximate a bottom portion of said dowel sleeve to create a tapered inner face of said dowel sleeve;
a thrust retainer having a tapered outer face and an axial inner bore extending through at least an upper portion thereof, said axial inner bore having threads therein, and wherein said tapered outer face tapers from a narrow portion proximate a top portion of said thrust retainer to a wider portion proximate a bottom portion of said thrust retainer; and
a bolt having a head and a shank portion, said shank portion including threads on an outer portion thereof, said shank portion outer threads being shaped and sized to mate with said thrust retainer inner bore threads,
wherein said thrust retainer tapered outer face and dowel sleeve tapered inner face are shaped such that when a top portion of said thrust retainer is placed within a bottom portion of said dowel sleeve axial bore and said bolt is inserted into said thrust retainer axial inner bore and tightened, the force of said thrust retainer tapered outer face against said dowel sleeve tapered inner face causes generally uniform expansion of said dowel sleeve.

2. The expanding dowel rod structure of claim 1, further comprising a nub located on said thrust retainer tapered outer face shaped to be slidably received in said dowel sleeve slot.

3. The expanding dowel rod structure of claim 2, wherein said nub is located on a lower portion of said thrust retainer tapered outer face.

4. The expanding dowel rod structure of claim 2, wherein said nub is shaped so that a top portion thereof does not protrude outward of said dowel sleeve slot.

5. The expanding dowel rod structure of claim 4, wherein said nub is wedge-shaped.

6. The expanding dowel rod structure of claim 1, wherein taper angles of said thrust retainer outer face and said dowel sleeve inner face are approximately the same.

7. The expanding dowel rod structure of claim 1, wherein a taper angle of said thrust retainer outer face is approximately 10 degrees.

8. The expanding dowel rod structure of claim 1, further comprising a washer positioned under said head of said bolt.

9. The expanding dowel rod structure of claim 1, wherein said dowel sleeve tapered inner face is conical in shape.

10. The expanding dowel rod structure of claim 1, wherein said dowel sleeve and said thrust retainer are formed from carbon steel.

11. The expanding dowel rod structure of claim 1, wherein said thrust retainer outer face is conical in shape.

12. The expanding dowel rod structure of claim 1, wherein said thrust retainer outer face is pyramidal in shape.

13. The expanding dowel rod structure of claim 1, wherein said bolt head further comprises a unitary washer portion.

14. An expanding dowel rod structure, comprising:
a dowel sleeve having a cylindrical outer face, a shoulder located on a top portion thereof, an axial bore therethrough, and a slot extending through said dowel sleeve for an entire length thereof, wherein said dowel sleeve axial bore tapers from a narrow portion proximate a top of said dowel sleeve to a wider portion proximate a bottom portion of said dowel sleeve to create a conically shaped tapered inner face of said dowel sleeve;
a thrust retainer having a conically shaped tapered outer face and an axial inner bore extending through at least an upper portion thereof, said axial inner bore having threads therein, a nub located on the outer face of said thrust retainer shaped to be slidably received in said dowel sleeve slot, and wherein said tapered outer face tapers from a narrow portion proximate a top portion of said thrust retainer to a wider portion proximate a bottom portion of said thrust retainer; and
a bolt having a head and a shank portion, said shank portion including threads on an outer portion thereof, said shank portion outer threads being shaped and sized to mate with said thrust retainer inner bore threads, and including a washer positioned under said head,
wherein said thrust retainer tapered outer face and dowel sleeve tapered inner face are shaped such that when a top portion of said thrust retainer is placed within a bottom portion of said dowel sleeve axial bore and said bolt is inserted into said thrust retainer axial inner bore and tightened, the force of said thrust retainer tapered outer face against said dowel sleeve tapered inner face causes generally uniform expansion of said dowel sleeve.

15. The expanding dowel rod structure of claim 14, wherein said nub is shaped so that a top portion thereof does not protrude outward of said dowel sleeve slot.

16. The expanding dowel rod structure of claim 14, wherein said bolt head and said washer are formed as a unitary piece.

17. The expanding dowel rod structure of claim 14, wherein taper angles of said thrust retainer outer face and said dowel sleeve inner face are approximately the same.

18. The expanding dowel rod structure of claim 14, wherein a taper angle of said thrust retainer outer face is approximately 10 degrees.

19. The expanding dowel rod structure of claim 14, having a band portion located proximate a bottom portion of said thrust retainer outer face.

20. An expanding dowel rod structure, comprising:
a dowel sleeve having a cylindrical outer face, a shoulder located on a top portion thereof, an axial bore therethrough, and a slot extending through said dowel sleeve for an entire length thereof, wherein said dowel sleeve axial bore tapers from a narrow portion proximate a top of said dowel sleeve to a wider portion proximate a bottom portion of said dowel sleeve to create a conically shaped tapered inner face of said dowel sleeve;
a thrust retainer having a conically shaped tapered outer face and an axial inner bore extending through at least an upper portion thereof, said axial inner bore having threads therein, a nub located on the outer face of said thrust retainer shaped to be slidably received in said dowel sleeve slot, and wherein said tapered outer face tapers from a narrow portion proximate a top portion of said thrust retainer to a wider portion proximate a bottom portion of said thrust retainer; and
a bolt having a head and a shank portion, said shank portion including threads on an outer portion thereof, said shank portion outer threads being shaped and sized to mate with said thrust retainer inner bore threads, and including a washer positioned under said head,
wherein said thrust retainer tapered outer face and dowel sleeve tapered inner face have taper angles that are approximately the same and are shaped such that when a top portion of said thrust retainer is placed within a bottom portion of said dowel sleeve axial bore and said bolt is inserted into said thrust retainer axial inner bore and tightened, the force of the underside of said washer against said dowel sleeve shoulder causes said thrust retainer outer face to press up and into said outer sleeve inner face causing generally uniform outward expansion of said dowel sleeve.
